(19) United States
(12) Patent Application Publication
(10) Pub. No.: US 2014/0332289 A1
(43) Pub. Date: Nov. 13, 2014

(54) System and Method for Mixing Ingredients of Food and Beverage Recipes

(71) Applicant: John Michael Gallagher, JR., SICKLERVILLE, NJ (US)

(72) Inventor: John Michael Gallagher, JR., SICKLERVILLE, NJ (US)

(73) Assignee: EBC SERVICES LLC, SICKLERVILLE, NJ (US)

(21) Appl. No.: 14/259,131

(22) Filed: Apr. 22, 2014

Related U.S. Application Data
(60) Provisional application No. 61/820,622, filed on May 7, 2013.

(51) Int. Cl. G01G 19/414; H04W 4/00; C12G 3/06

(52) U.S. Cl. CPC G01G 19/414; C12G 3/06; H04W 4/008
USPC 177/1; 177/25.13

(57) ABSTRACT

The food and beverage ingredient mixing system and that utilizes a platform for placing a container, a Bluetooth module for receiving an electronic recipe wirelessly from a mobile device, a processor to process the electronic recipe, a display to communicate which ingredients to add to the container, when to start adding said ingredients, and when to stop, along with any special text instructions in the recipe, and one or a plurality of weight sensors for measuring the mass of ingredients added to the container on the platform

### CROSS-REFERENCE TO RELATED APPLICATIONS

This application claims the benefit of U.S. Provisional Application No. 61/820622, Recipe Weighing Scale, filed May 7, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to the field of weighing scales. More particularly, the described embodiments relate to a digital recipe-mixing scale system capable of connecting to a mobile device.

2. Description of the Related Art

Traditionally, food and beverage recipes in print and on the internet have used volume for describing how much of each ingredient is used in a recipe. The user has the task of scaling the recipe to different sizes, measuring the ingredients of the recipe using devices such as measuring cups, measuring spoons, jiggers, shot glasses, and constantly referring back to the recipe to ensure the proper steps and procedures are followed when combining the ingredients.

To combine the ingredients of a recipe such as the cocktail known as a “Jack and Coke” using traditional procedures and devices would be done similar to the following procedures:

### Drink Recipe: 1 Ounce Kentucky Whiskey, 3 Ounces Cola

1) The user would have to scale the recipe to the size drink they would like to make. If the user would like to make a 6 ounce drink, the user would have to first come up with the percentage of each ingredient. The total ounce of the current recipe is 4 ounces (3 ounces of Cola, 1 ounce of Kentucky Whiskey). To get the percentage of each component the user would have to divide each ingredient by the total and multiply by 100 (1 ounce/4 ounces=0.25×100 =25% Kentucky Whiskey & 3 ounces/4 ounces=0.75×100=75% Cola). Now that the user knows that the cocktail is 25% Kentucky Whiskey and 75% Cola, the user can then scale the recipe to a 6 ounce cocktail (75/100×6=4.5 ounces Cola & 25/100×6=1.5 ounces Kentucky Whiskey).
2) The user would then add ice to the glass
3) The user would then measure 1.5 ounces of Kentucky Whiskey using a measuring cup, measuring spoon, shot glass, or other similar device to measure volume.
4) The user would then add the 1.5 ounces of Kentucky Whiskey to the glass.
5) The user would then measure 4.5 ounces of Cola using a measuring cup, measuring spoon, shot glass, or other similar device to measure volume.
6) The user would then add the 4.5 ounces of Cola, to the glass.
7) The user would then stir the mixture and serve.

During this whole process, the user has to constantly refer back to the text recipe so that they follow the exact steps to mix the cocktail correctly, and in order. This whole process is very time consuming, is prone to human error, is complicated, and frustrating especially for novices. The same holds true for food recipes. Volume is often very difficult to measure accurately with food products that are irregularly shaped. Thus, a food and beverage ingredient mixing system solving the aforementioned problem is desired.

### SUMMARY OF THE INVENTION

In one embodiment, the food and beverage ingredient mixing system relates to a mobile device running an application which allows the users to select baking recipes from a database, select the size of the recipe the user would like to make, and transmit that recipe wirelessly to a digital scale with a platform for resting a mixing bowl or other type of food container. The recipe is received by a Bluetooth module which transfers the recipe to a processor, or micro-controller, which outputs to a display informing the user of which ingredient to add, when to start adding it, when to stop adding it, and any special instructions all in a step-by-step format, in essence, walking the user though mixing the recipe. The processor reads the weight sensors and compares the current reading to the total amount of an ingredient in a recipe so that the processor can output to the display how much more ingredient the user must add to get to the total of the ingredient in the recipe.

In a further embodiment, the food and beverage ingredient mixing system relates to a mobile device running an application which allows the users to select beverage recipes from a database, select the size of the recipe the user would like to make, and transmit that recipe wirelessly to a digital scale with a platform for resting a cocktail glass or cocktail shaker. The recipe is received by a Bluetooth module within the scale which transfers the recipe to a processor, or micro-controller, which outputs to a display informing the user of which ingredient to add, when to start adding it, when to stop adding it, and any special instructions all in a step-by-step format, in essence, walking the user though mixing the recipe. The processor reads the weight sensors and compares the current reading to the total amount of an ingredient in a recipe so that the processor can output to the display how much more ingredient the user must add to get to the total of the ingredient in the recipe. One or a plurality of Light Emitting Diodes (LED's) are disposed in or below the platform which allow the drink glass or cocktail shaker to be illuminated. These LED's are controlled by the microcontroller and are used as an indicator to the user such as when to start adding ingredients or to stop adding ingredients.

In a further embodiment, the food and beverage ingredient system relates to a method for mixing the ingredients in food and beverage recipes using a mass-based percent recipe. In this method, recipes are stored and scaled according to a percent ratio of one ingredients mass compared to the total mass of the entire recipe. This method involves dividing the mass of each ingredient by the total mass of the entire recipe to come up with a mass-based percent for each ingredient. The mass-based percent for each ingredient is then stored in an application. The recipe can then be scaled to any size.

These and other features of the present invention will become readily apparent upon further review of the following specification and drawings

### BRIEF DESCRIPTION OF THE DRAWINGS

FIG. 1 is a perspective view of a digital weighing scale of the present invention;

FIG. 2 is a top view of a digital weighing scale of the present invention;

FIG. 3 is a side view of a digital weighing scale of the present invention.

FIG. 4 is a bottom view of a digital weighing scale of the present invention.

FIG. 5 is an internal bottom view of a digital weighing scale of the present invention.

FIG. 6 is a perspective view of a food and beverage recipe mixing system of the present invention.

FIG. 7 is a perspective view of a digital weighing scale of the present invention.

### DETAILED DESCRIPTION OF THE INVENTION

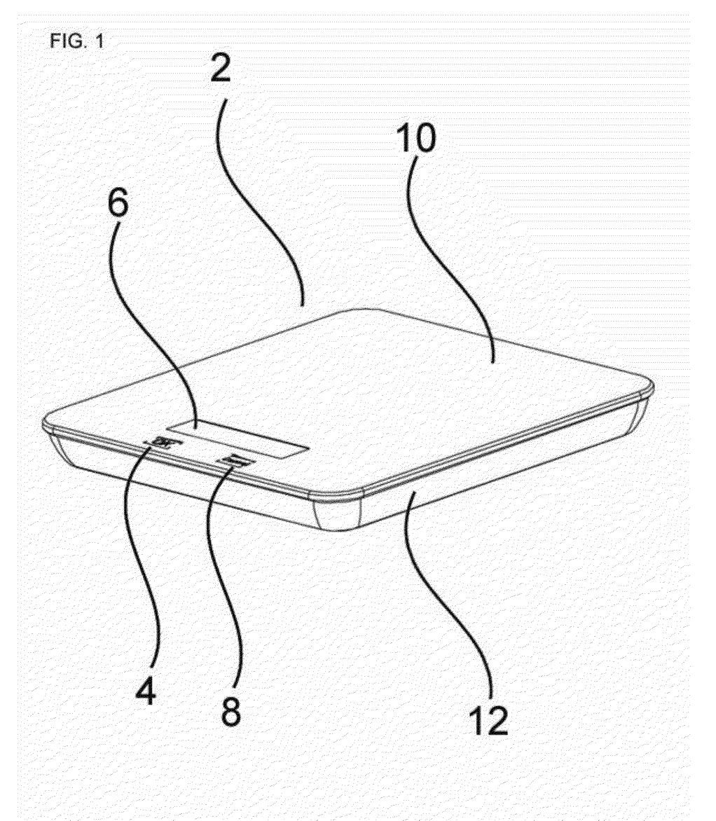

Referring now to the invention in more detail, in FIG. 1 there is shown a perspective view of a digital weighing scale 2 having one or more buttons 4, 8, a display 6, a platform 10, and a base 12. The buttons 4, 8, base 12, and display 6 are all attached to the platform 10.

In more detail, still referring to the invention of FIG. 1, the platform 10 is used to support a container or, multiple containers, such as a drinking glass or bowl. The display 6 is used to display information to the user. The buttons 4, 8 are used by the user to communicate with the invention. The base 12 is used to protect the components inside the base 12.

In further detail, still referring to the invention of FIG. 1, the platform 10 is sufficiently wide enough to support a small drinking glass or a large bowl, such as about 3 to 8 inches wide, about 5 to 12 inches deep, and about ⅛ inch to 1 inch thick. The display 6 is sufficiently large enough for the user to read when the invention is at counter-height and the user is standing, such as about 2 to 4 inches wide and about 1 to 2 inches deep. The buttons 4, 8 are sufficiently large enough for a human finger to press, such as about ½ to 1 inch wide and about ½ to 1 inch deep. The base 12 is sufficiently large enough to house all the components inside the base 12 but not larger than the platform 10, such as about 2 & ¾ to 7 & ¾ inches wide, about 4 & ¾ to 11 & ¾ deep, and about ½ to 2 inches thick.

The construction details of the invention as shown in FIG. 1 are that the digital weighing scale 2 maybe made of wood, glass, metal, plastic or any other sufficiently rigid material. Further, the various components of the digital weighing scale 2 can be made of different materials.

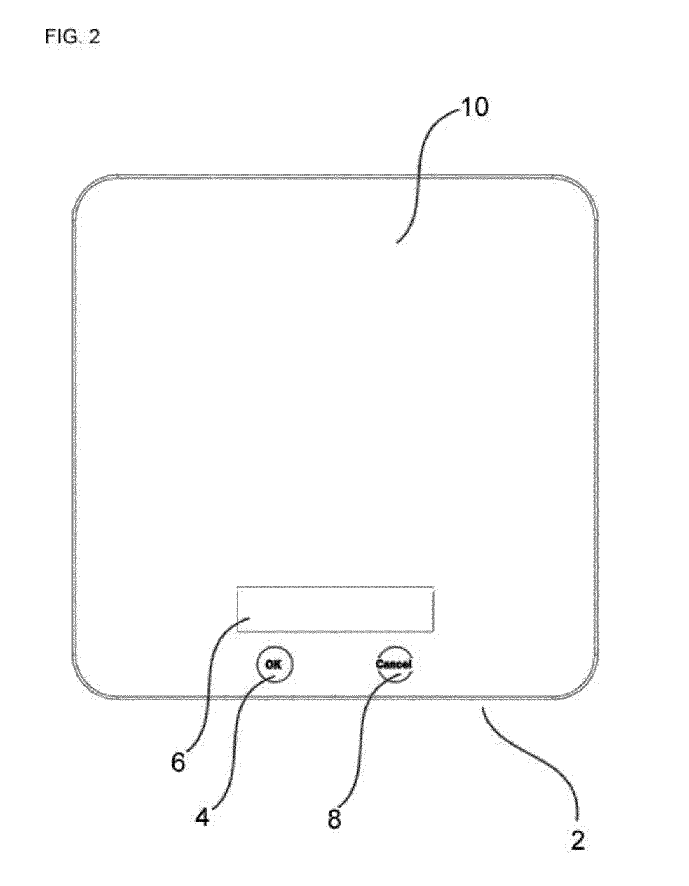

Referring now to the invention in more detail, in FIG. 2 there is shown a top view of a digital weighing scale 2 having one or more buttons 4, 8, a display 6, a platform 10, and a base 12. The buttons 4, 8, base 12, and display 6 are all attached to the platform 10.

In more detail, still referring to the invention of FIG. 2, the platform 10 is used to support a container or, multiple containers, such as a drinking glass or bowl. The display 6 is used to display information to the user. The buttons 4, 8 are used by the user to communicate with the invention. The base 12 is used to protect the components inside the base 12.

In further detail, still referring to the invention of FIG. 2, the platform 10 is sufficiently wide enough to support a small drinking glass or a large bowl, such as about 3 to 8 inches wide, about 5 to 12 inches deep, and about ⅛ inch to 1 inch thick. The display 6 is sufficiently large enough for the user to read when the invention is at counter-height and the user is standing, such as about 2 to 4 inches wide and about 1 to 2 inches deep. The buttons 4, 8 are sufficiently large enough for a human finger to press, such as about ½ to 1 inch wide and about ½ to 1 inch deep. The base 12 is sufficiently large enough to house all the components inside the base 12 but not larger than the platform 10, such as about 2 & ¾ to 7 & ¾ inches wide, about 4 & ¾ to 11 & ¾ deep, and about ½ to 2 inches thick.

The construction details of the invention as shown in FIG. 2 are that the digital weighing scale 2 may be made of wood, glass, metal, plastic or any other sufficiently rigid material. Further, the various components of the digital weighing scale 2 can be made of different materials.

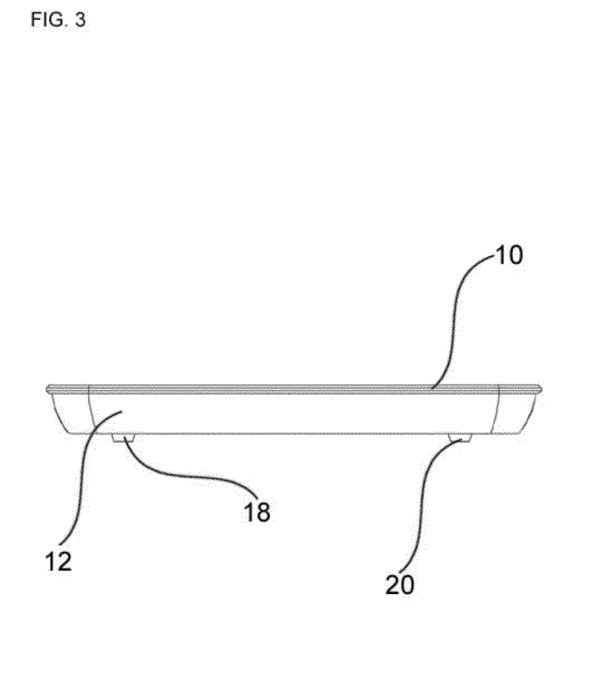

Referring now to the invention in more detail, in FIG. 3 there is shown a side view of a digital weighing scale 2 having a platform 10, a base 12, and 4 feet 18,20. The base 12 is attached to the platform 10.

In more detail, still referring to the invention of FIG. 3, the platform 10 is used to support a container or, multiple containers, such as a drinking glass or bowl. The base 12 is used to protect the components inside the base 12. The feet 18,20 are attached to the weight sensors and extend through the base 12 so they can make contact with the surface that the digital weighing scale 2 is resting on, such as a counter or table.

In further detail, still referring to the invention of FIG. 3, the platform 10 is sufficiently wide enough to support a small drinking glass or a large bowl, such as about 3 to 8 inches wide, about 5 to 12 inches deep, and about ⅛ inch to 1 inch thick. The base 12 is sufficiently large enough to house all the components inside the base 12 but not larger than the platform 10, such as about 2 & ¾to 7 & ¾ inches wide, about 4 & ¾ to 11 & ¾ deep, and about ½ to 2 inches thick. The feet 18,20 are sufficiently large enough to extend through the base 12, such as about ¼ to 2 inches wide, about ¼ to 2 inches deep, and about ¼ to 2 inches thick.

The construction details of the invention as shown in FIG. 3 are that the digital weighing scale 2 may be made of wood, glass, metal, plastic or any other sufficiently rigid material. Further, the various components of the digital weighing scale 2 can be made of different materials.

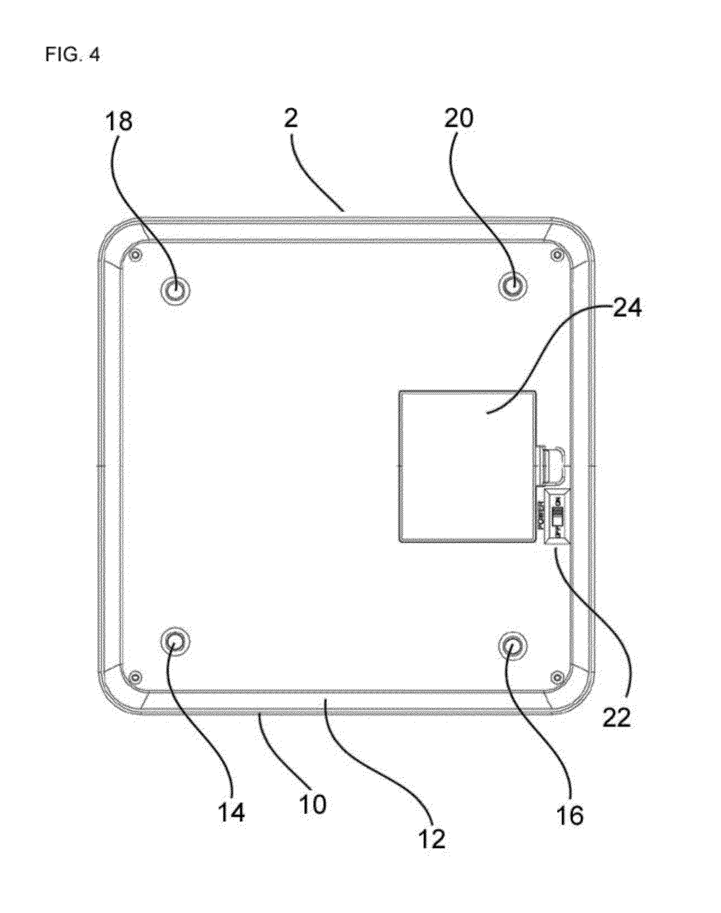

Referring now to the invention in more detail, in FIG. 4 there is shown a bottom view of a digital weighing scale 2 having a platform 10, a base 12, 4 feet 14,16,18,20, a power switch 22, and a battery compartment 24. The base 12, power switch 22, and battery compartment 24, are attached, to the platform 10.

In more detail, still referring to the invention of FIG. 4, the platform 10 is used to support a container or, multiple containers, such as a drink glass or bowl. The base 12 is used to protect the components inside the base 12. The feet 14,16,18,20 are attached to the weight sensors and extend through the base 12 so they can make contact with the surface that the digital weighing scale 2 is resting on, such as a counter or table. The power switch 22 is used to turn on power to the device. The battery compartment 24 is used to hold the batteries which power the device.

In further detail, still referring to the invention of FIG. 4, the platform 10 is sufficiently wide enough to support a small drink glass or a large bowl, such as about 3 to 8 inches wide, about 5 to 12 inches deep, and about ⅛ inch to 1 inch thick. The base 12 is sufficiently large enough to house all the components inside the base 12 but not larger than the platform 10, such, as about 2 & ¾ to 7 & ¾ inches wide, about 4 & ¾ to 11 & ¾ deep, and about ½ to 2 inches thick. The feet 14,16,18,20 are sufficiently large enough to extend through the base 12, such as about ¼ to 2 inches wide, about ¼ to 2 inches deep, and about ¼ to 2 inches thick. The power switch 22 is sufficiently large enough to accommodate a human finger for switching it on such as about ¼ to ½ inches wide and about ¼ to ½ inches deep. The battery compartment 24 is sufficiently large enough to house 4 AAA batteries, such as about 2 to 3 inches wide and about 2 to 3 inches deep.

The construction details of the invention as shown in FIG. 4 are that the digital weighing scale 2 may be made of wood, glass, metal, plastic or any other sufficiently rigid material. Further, the various components of the digital weighing scale 2 can be made of different materials.

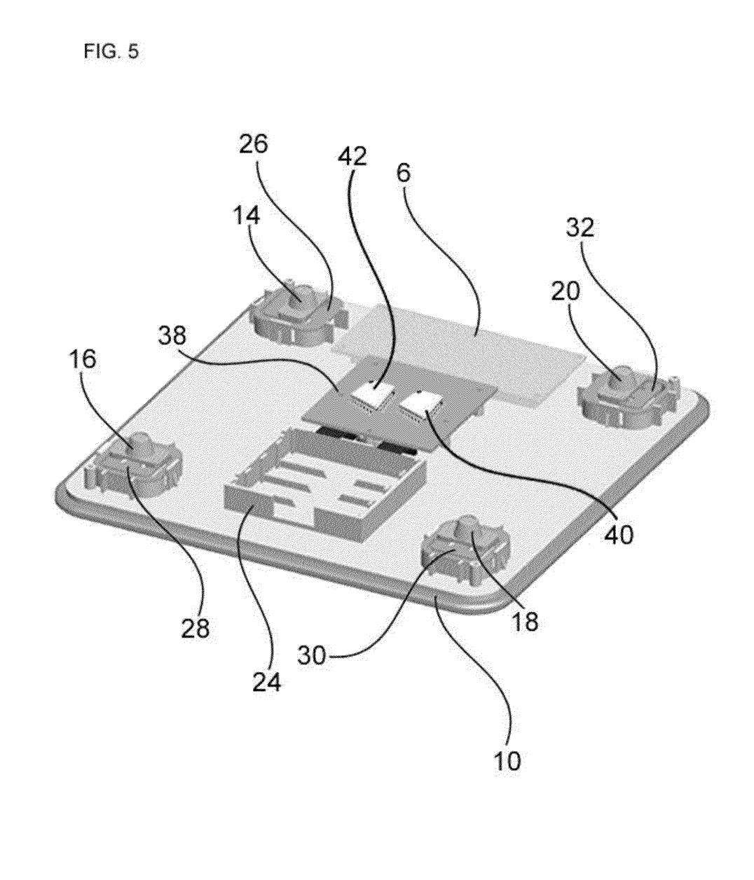

Referring now to the invention in more detail, in FIG. 5 there is shown a digital weighing scale 2 having a platform 10, 4 weight sensors 26,28,30,32, 4 feet 14,16,18,20, a display 6, a printed circuit board, a microcontroller 40, a Bluetooth module 42, and a battery compartment 24.

In more detail still referring to the invention of FIG. 5, the platform 10 is used to support a container or, multiple containers, such as a drink glass or bowl. The weight sensors 26,28,30,32 are used to sense the weight that is being applied to the platform 10. The weight sensors 26,28,30,32 are attached to the platform 10. The feet 14,16,18,20 are attached to the weight sensors 26,28,30,32 and make contact with the surface that the digital weighing scale 2 is sitting on, such as a counter or table. The display 6 and the printed circuit board 38 are attached to the platform 10. The microcontroller 40 and the Bluetooth module 42 are mounted to the printed circuit board 38. This display 6 provides information to the user such as which components are to be mixed, when to mix them, and how much is left to add before stopping. The microcontroller 40 contains the software that reads the recipe received by the Bluetooth module 42 and automates the process of mixing the components of the recipe. The battery compartment 24 houses the batteries that are used to power the device and is attached to the platform 10.

In further detail, still referring to the invention of FIG. 5, the platform 10 is sufficiently wide enough to support a small drinking glass or a large bowl, such as about 3 to 8 inches wide, about 5 to 12 inches deep, and about ⅛ inch to 1 inch thick. The four weight sensors 26,28,30,32 are large enough to sufficiently support a small, glass of liquid, or a large bowl filled with liquids and or solids, such as about 1 to 3 inches wide, about 1 to 3 inches deep, and about ¼ to 2 inches thick. The feet 14,16,18,20 are sufficiently large enough to extend through the base, such as about ¼ to 2 inches wide, about ¼ to 2 inches deep, and. about ¼ to 2 inches thick. The Bluetooth module 42 is small enough to be concealed inside the digital weighing scale 2, such as about ½ to 1 & ½ inches wide and about ½ to 1 & ½ inches deep and about ⅛ to ½ inch thick. The microcontroller 40 is small enough to be concealed inside the digital weighing scale 2, such as about 1 to 2 inches wide and about ½ to 1 inch deep and about ⅛ to ½ inch thick.

The construction details of the invention as shown in FIG. 5 are that the digital weighing scale 2 may be made of wood, glass, metal, plastic or any other sufficiently rigid material. Further, the various components of the digital weighing scale 2 can be made of different materials.

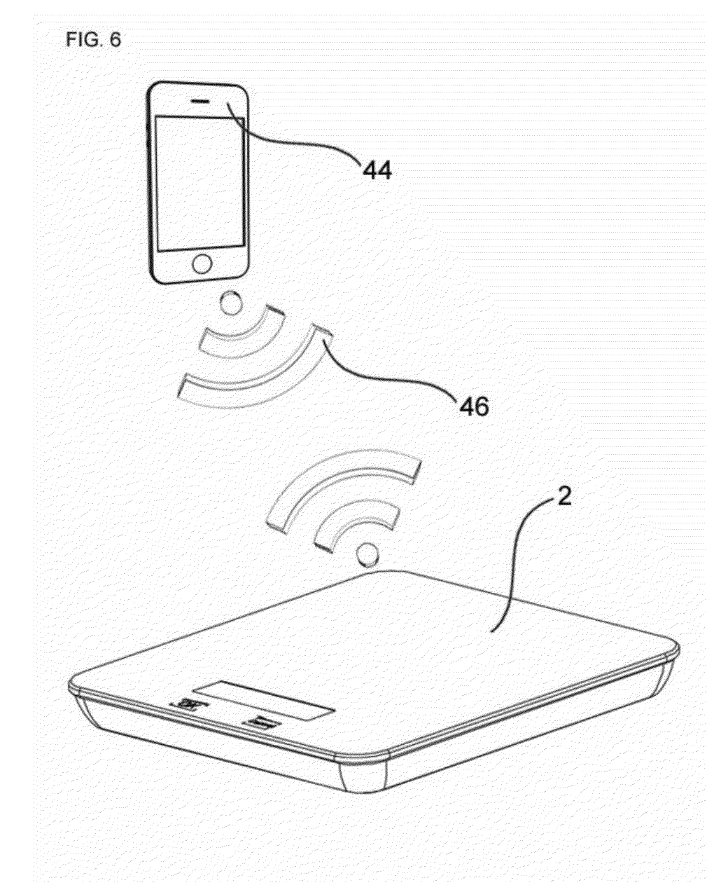

Referring now to the invention in more detail, in FIG. 6 there is shown a food and beverage recipe mixing system having a mobile device 44 capable of connecting 46 to a digital scale 2.

In more detail, still referring to the invention of FIG. 6, the mobile device contains a database of food and or beverage recipes that are wirelessly transmitted to the digital scale 2 for mixing.

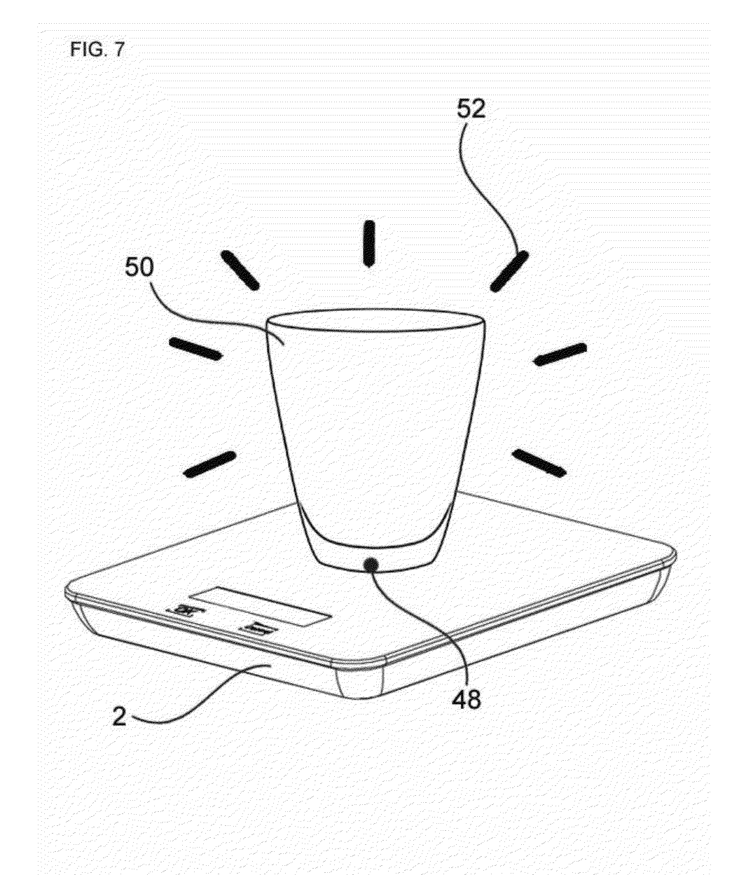

Referring now to the invention in more detail, in FIG. 7 there is perspective view of a digital scale 2 in one embodiment where the platform has one or a plurality of Light Emitting Diodes (LED's) 48 embedded inside or below it allowing a drink glass 50 or cocktail shaker to be illuminated.

The advantages of the present invention include, without limitation, that it allows a user to download food and drink recipes that are sent from an application on a mobile device and guide the user through mixing the components of the mass-based recipe.

In broad embodiment, the present invention is a digital weighing scale that receives recipes for various mixtures via Bluetooth Wireless Technology from a mobile device and allows a user to measure each of the components of the mass-based percent recipe in succession in a container.

The recipe may consist of a single component or multiple components that may be solid or liquid. The present invention receives, but not limited to, component names, component masses, and recipe instructions from a mobile device. The user places their drinking glass or food container on the device. When the recipe is received from an external device, the present invention tares or zero's-out the current scale reading leaving it at zero. Then, the present invention displays the name of the first component on the display of the device. The user then pours or adds the displayed component slowly to the container. As the user adds the component, a progress indicator moves across display showing the user how much they have left to add before they must stop. When the user reaches the total mass of the component in the recipe, the display informs the user to stop adding the component. The present invention then tares or zero's out the current scale reading. The process then repeats for each component in the recipe until all components of the recipe have been added. Sometimes parts of the recipe are instructions. In the case of an instruction, the instruction displays on the display. The user may or may not have to press a button on the present invention to notify the present invention that the step has been completed and to move onto the next part of the recipe. When all components have been added, the present invention notifies the user that the recipe has been completed leaving the user with the desired mixture.

An example of the electronic recipe that may be received from the mobile device would be as follows:

I: Place a drink glass on the scale

I: Add ice to the drink glass

C: Rum::200

C: Coke:500

The “I” in the recipe code stands for Instruction, and the C in the recipe code stands for Component (or ingredient). The numerical value in each component string represents the mass of that component in grams. The mobile device calculated those masses based on the size cocktail the user desired to make. The mass-based percent recipe for this cocktail was as follows:

1) Place a drink glass on the scale

2) Add ice to the drink glass

3) 25% Rum

4) 75% Coke

The application on the mobile device calculates the total mass of the size of the drink the user would like to make and applies the mass-based percentage recipe above to that size drink to come up with the mass of each component.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A food and beverage ingredient mixing system, comprising;
a. a digital scale having
i. platform for holding a food or beverage container,
ii. means of sensing mass,
iii. means of receiving an electronic recipe wirelessly from a mobile device,
iv. means of analyzing said electronic recipe received and allowing the user to mix said recipe in a procedural manner,
v. means of displaying information to the user, and
vi. means of receiving inputs from the user
b. a mobile device having
i. means of communicating to the digital scale,
ii. a database containing a plurality of mass-based percentage food and beverage recipes, and
iii. means of scaling the recipe size

2. The food and beverage ingredient mixing system of claim 1, wherein said platform is water resistant.

3. The food and beverage ingredient mixing system of claim 1, wherein said means of receiving an electronic recipe wirelessly accomplished using Bluetooth Technology.

4. The food and beverage ingredient mixing system of claim 1, wherein said means of receiving inputs from the user is comprised of a plurality of capacitive-touch buttons.

5. The food and beverage ingredient mixing system of claim 1, wherein said means of analyzing the electronic recipe received to allow the user to mix said recipe in a procedural manner is comprised of a microcontroller that can process the electronic recipe.

6. A cocktail ingredient mixing system, comprising;
a. a digital scale having
i. platform for holding a cocktail glass or cocktail shaker,
ii. means of sensing mass,
iii. means of receiving an electronic recipe wirelessly from a mobile device,
iv. means of analyzing said electronic recipe received and allowing the user to mix said recipe in a procedural manner,
v. means of displaying information to the user,
vi. means of receiving inputs front the user, and
vii. means of illuminating said cocktail glass or cocktail shaker a plurality of colors
b. a mobile device having
i. means of communicating to the digital scale,
ii. a database containing a plurality of mass-based percentage cocktail recipes, and
iii. means of scaling the recipe size

7. The cocktail ingredient mixing system of claim 6, wherein said platform is water resistant

8. The cocktail ingredient mixing system of claim 6, wherein said means of receiving an electronic recipe wirelessly is accomplished using Bluetooth Technology.

9. The cocktail ingredient mixing system of claim 6, wherein said means of receiving inputs from the user is comprised of a plurality of capacitive-touch buttons.

10. The cocktail ingredient mixing system of claim 6, wherein said means of analyzing the electronic recipe received to allow the user to mix said recipe in a procedural manner is comprised of a microcontroller that can process the electronic recipe.

11. The cocktail ingredient mixing system of claim 6, wherein said means of illuminating said cocktail glass or cocktail shaker is comprised of one or a plurality of Light Emitting Diodes (LEDs).

12. Method for mixing food and beverage recipes using a mass-based percent recipe, the method comprising;
a) receiving a mass based percent recipe wirelessly from a mobile device,
b) processing said recipe by a microcontroller on the digital sale,
c) the digital scale instructing the user which Ingredients to add, when to add them, and when to stop, and
d) the digital scale displaying any instructions in the recipe to the user.

13. Method for using a mass-based percent recipe for food and beverage recipes, the method comprising;
a) a mobile device with a database containing mass-based percent recipes,
b) said recipes where each ingredient's value is it's percent of the total mass of all ingredients in said recipe, and
c) said recipes where instructions in the recipe are stored along with the mass-based percentages of the ingredients.
